(19) United States
(12) Patent Application Publication
(10) Pub. No.: US 2012/0315457 A1
(43) Pub. Date: Dec. 13, 2012

(54) FIBERGLASS COMPOSITES WITH IMPROVED FLAME RESISTANCE AND METHODS OF MAKING THE SAME

(76) Inventors: Guodong Zheng, Highlands Ranch, CO (US); Jawed Asrar, Englewood, CO (US)

(21) Appl. No.: 13/157,548

(22) Filed: Jun. 10, 2011

(51) Int. Cl. B32B 5/02; B05D 3/02

(52) U.S. Cl. 428/292.1; 427/397.7

(57) ABSTRACT

Fiberglass products with increased flame resistance are described. The products may include fiberglass-containing thermal insulation that include a plurality of glass fibers that are at least partially coated with a vermiculite-containing flame retardant. The products may further include fiberglass composites that are about 50 wt. % to about 98 wt. % glass fibers, about 2 wt. % to about 50 wt. % of a binder; and a flame retardant that includes vermiculite. Also described are methods of making fiberglass products with increased flame resistance. These methods may include the steps of contacting glass fibers and/or fiberglass composite with a flame retardant mixture that includes vermiculite.

### BACKGROUND OF THE INVENTION

Fiberglass, like other glass materials, is non-flammable and not considered a fire danger in building materials and other products. However, modern fiberglass insulation products are also expected to act as barriers to the spread of fire in a home, building, duct, or piece of equipment. For this reason, fiberglass insulation is evaluated for its ability to resist the penetration of flames through the insulation.

These evaluations revealed that the rate of flame penetration can be effected by the properties of the glass fibers, including their basis weight, distribution, diameter, and orientation. However, optimizing just these properties may not be enough to meet the ever more stringent standards for fire and flame resistance set by widely followed standard setting bodies like Underwriters Laboratories.

One area that the standard setting bodies are focusing on is the effect of high temperatures on the ability of fiberglass insulation to resist flame penetration. When temperatures rise above the glass softening temperature for the glass fibers, there is the potential for holes and channels to form in the insulation that may make it easier for flame propagation. Manufacturers have responded by investigating materials that can form decomposition products (e.g., char) around the glass fibers that help structurally support the fibers, thermally insulate the fibers, and/or suppress flame propagation around the fibers.

One such material is the binder commonly used in the fiberglass batt, and especially the mats, of the insulation. Historically, these binders were made from phenol-formaldehyde (PF) and urea-formaldehyde (UF) formulations that are being phased out due to concerns about formaldehyde emissions. Increasingly, formaldehyde-free binder compositions are being used that have no risk of decomposing into formaldehyde. Examples of these compositions include binders made by esterification reactions between the carboxylic acid groups in polycarboxy polymers and the hydroxyl groups in alcohols. Examples also include the use of starches, sugars, proteins, and polyamines, among other classes of compounds, in making formaldehyde-free binders. While the rapid development of many different formaldehyde-free binder compositions have reduced environmental and health risks associated with the older phenol/urea formaldehyde formulations, it has also added to the complexity of developing binders with increased fire and flame resistance.

Thus, there is a need for new compounds and fabrication methods for making fiberglass batts and facers for insulation with improved flame resistance properties without significantly increased health and environmental risks. These and other issues are address in the present application.

### BRIEF SUMMARY OF THE INVENTION

Methods and products are described treating glass fibers with flame retardant compositions to increase the flame resistance of the fibers. The flame retardant compositions may include vermiculite that provides structural support and thermal insulation to glass fibers exposed to a flame front. The vermiculite is chemically inert in the flame retardant composition, and thermally stable at temperatures above the melting point of the glass fibers. When fiberglass insulation made from the fibers are exposed to intense heat and flames, the vermiculite particles (e.g., platelets) can expand to enhance the structural integrity of heat softened glass fibers. The thermally insulating properties of vermiculite also slow heat conduction to the fibers, reducing their softening and melting rate.

In addition to the vermiculite, the flame retardant compositions may include flame retardant compounds such as phosphorous compounds, metal hydroxides, carbon black, and/or halogen-containing compounds, among others. In many instances, these flame retardant compounds interfere with the chemical reactions of flame propagation by reacting with energized species in the flames and/or displacing combustible gases with more stable constituents such as water, nitrogen and carbon dioxide. They may also provide structural and thermal insulation support to the glass fibers.

Embodiments of the invention include fiberglass-containing thermal insulation with increased resistance to flame penetration. The insulation may include glass fibers at least partially coated with a vermiculite-containing flame retardant.

Embodiments of the invention also include fiberglass composites with improved flame resistance. The composites may include about 50 wt. % to about 98 wt. % glass fibers; about 2 wt. % to about 50 wt. % of a binder; and a flame retardant that includes vermiculite.

Embodiments of the invention still further include methods of making glass fibers with improved flame resistance. The methods may include, among other steps, contacting glass fibers with a flame retardant mixture comprising vermiculite. The glass fibers may then be dried to form the fibers with improved flame resistance.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A is a flowchart showing selected steps in methods of treating fiberglass to improve its flame resistance according to embodiments of the invention;

FIG. 1B is a flowchart showing selected steps in methods of making fiberglass composites according to embodiments of the invention;

FIG. 1C is a flowchart showing selected steps in additional methods of making fiberglass composites according to embodiments of the invention;

FIG. 1D is a flowchart showing selected steps in additional methods of making fiberglass composites according to embodiments of the invention;

FIG. 2 is a flowchart showing selected steps in a method of making a fiberglass-containing product according to embodiments of the invention;

FIG. 3 is a simplified illustration of a fiberglass product according to embodiments of the invention; and

FIGS. 4A&B are illustrations of vermiculite treated and untreated fiberglass insulation following a flame propagation test.

### DETAILED DESCRIPTION OF THE INVENTION

Fiberglass insulation is a non-flammable material that intrinsically meets most of the requirements for a fire resistant material. However, some applications and environments call for fiberglass products that can remain fire and flame resistant for a specified period of time at higher temperatures where the glass fibers can soften, deform, or even melt. Fiberglass products are described that include flame retardants that provide structural support, thermal insulation, and/or flame repressing properties to a fiberglass composite that extend the time fiberglass-containing products can suppress the propagation of fire and flames.

### Exemplary Fiberglass Composites

Exemplary fiberglass composites include glass fibers that are treated with a vermiculite-containing flame retardant. The composites may include fiberglass thermal insulation having improved flame resistance imparted by the vermiculate particles (e.g., platelets) attached to the surfaces of the glass fibers. The glass fibers may be held together by a polymer binder formed from a binder composition that may also include the flame retardant composition. When the composite include both fibers and binder, the glass fibers may make up about 50 wt. % to about 98 wt. %, and the binder may make up about 2 wt. % to about 50 wt. %, of the composite.

The glass fibers may have a variety of spatial dimensions depending on the composite. For example, the fibers may have an average length of about 1 cm to about 10 cm (e.g., 1.9±0.2 cm), and an average diameter of about 3 μm to about 20 μm (e.g., about 10 μm to about 14 μm), among other ranges. The fibers may also have a variety of distribution characteristics such as basis weight. For example, the basis weight of the glass fibers may range from about 135 g/m² to about 700 g/m². Typically, basis weights ranging from about 300 g/m² to about 700 g/m² are considered higher weight insulation (e.g., flexible duct insulation typically ranges from about 350 g/m² to about 700 g/m²), while insulation with basis weights ranging from about 135 g/m² to about 300 g/m² are considered lower weight insulation. The glass fibers may be arranged in a woven or non-woven fashion in the mat.

In some embodiments, the glass fibers may be blended with other types of fibers, such as mineral fibers, graphite fibers, synthetic polymer fibers (e.g., polyethylene, polypropylene, polyester, nylon, etc.), natural fibers (e.g., cotton, hemp, jute, flax, kenaf, etc.), and cellulose fibers, among other types of fibers. The amount of glass fibers in the composite may range from about 100 wt. % of the fibers to 90 wt. %, 80% wt. %, 75 wt. %, etc.

The glass fibers may also be held together by a binder that is introduced at the same time or independently from the flame retardant. The binder may include one or more of an acrylic binder, a urea-formaldehyde binder, a phenol-formaldehyde binder, a silicate binder, a melamine-formaldehyde binder, and a latex binder, among other kinds of binders. The binders may also include starches, sugars, and/or proteins, having varying degrees of polymerization, among other materials.

The binders may be made from binder compositions that include precursors that form the binder. These precursors may include monomers and/or intermediate oligomers and polymers that are polymerized in the final binder. Exemplary binder precursors may include carboxylic acids, anhydrides, alcohols, polyols, vinyl compounds, and polyols, among others. Binder precursors may also include polymerization catalysts, accelerators, pigments, defoamers, crosslinking agents, plasticizers, corrosion inhibitors, anti-microbial compounds, extenders, and/or anti-fungal compounds, among other kinds of compounds.

The flame retardant mixture and/or binders may also include filler materials such as kaolinite, mica, talc, fly ash, gypsum, montmorillonite, bentonite, smectite, calcium carbonate, clay, THA, and/or titanium dioxide, among other fillers. These fillers may be used to adjust, among other properties, the color, clarity, texture, weight, strength, flexibility, toughness, and flame/heat resistance of the composite. If fillers and flame retardant are added to the binder composition, exemplary ratios weight ratios of flame retardant to filler may include ranges from about 1:2 to about 2:1.

As noted above the flame retardant mixture may include vermiculite, a natural mineral whose composition includes a hydrated magnesium-iron-aluminum-silicate (i.e., a phyllosilicate). In some forms vermiculite's chemical formal may be represented as (MgFe,Al)₃(Al,Si)₄O₁₀(OH)₂.4H₂O. In additional forms, vermiculite's empirical formula may be represented as Mg_{1.8}Fe_{0.9}Al_{4.3}SiO₁₀(OH)₂.4H₂O. Vermiculite particles may be added to the fibers and/or binder composition as dry particles or a dispersion in a liquid solution (e.g., water).

The flame retardant may also include a phosphorous compound, expandable graphite, a metal hydroxide, carbon black, and/or a halogen-containing compound, among other compounds. These flame retardants may provide structural integrity and/or thermal insulation to softening glass fibers similar to vermiculite. Alternately or in addition, they may interfere chemically with flame propagation by neutralizing flame propagating species and/or displacing and diluting combustible gases with more stable species such as water and carbon dioxide.

For example, the flame retardant may include one or more phosphorous compounds such as polyphosphates, phosphate esters and phosphate amides, among other kinds of phosphorous compounds. Polyphosphates may include ammonium polyphosphates —[NH₄PO₃]ₙ— made from monomer units of an orthophosphate radical of a central P atom bonded to three oxygens that give the anion a negative charge that is balanced by the ammonium cation. While not wishing to be bound by a particular theory of how polyphosphates act as flame retardants, it is believed the polyphosphate polymer decomposes under heat to form phosphoric acid groups that act as acid catalysts in the dehydration of alcohol groups found in organic binders systems. This dehydration process temporarily destabilizes the phosphoric acid groups by converting them into phosphate esters that decompose to release carbon dioxide and regenerate the phosphoric acid group. The released carbon dioxide displaces combustible gases like molecular oxygen and decomposing organic compounds to help suppress flame propagation. Depending on the other binder constituents, the pressure from the buildup of the carbon dioxide may also help expand the volume of the binder to constrict or close channels for conducting flames and combustible gases through the composite.

The phosphorous compounds may also include organic phosphorous compounds such as organic phosphate esters having the formula P(═O)(OR)₃, wherein at least one of the R groups is a substituted or unsubstituted, saturated or unsaturated, halogenated or unhalogenated, alkyl, aryl, or phenyl moiety, among other organic moieties. Like the polyphosphates, these phosphorous compounds may be added to the binder composition and/or applied as a treatment to the glass fibers before they are mixed with the binder composition. When the organic phosphorous compounds are applied as a coating or part of a sizing composition on the glass fibers, they quickly decompose to form a char around the fibers when exposed to high heat and flames. The char provides both structural support and thermal insulation to the underlying glass fibers. It may also reduce the volume of interstitial spaces between the fibers to help reduce the velocity of hot air, combustion gases, etc., thought the composite.

The flame retardant may include one or more metal hydroxide compounds that release water in endothermic decompositions when exposed to sufficiently high temperatures. For example, magnesium hydroxide (Mg(OH)₂) decomposes at about 330° C. to form magnesium oxide (MgO) and water (H₂O). Similarly, aluminum tri-hydroxide (Al(OH)₃) decomposes about 230° C. to form aluminum oxide (Al₂O₃) and water. The water released suppresses combustion and flame propagation through the composite. In some embodiments, the metal hydroxides may be combined with carbon black in the fire retardant.

The flame retardant may include one or more halogen-containing compounds, such as organo-halogen compounds (e.g., a halogenated aliphatic compound). Exemplary halogen-containing compounds may include brominated aliphatic and/or aromatic compounds. When the halogen-containing compounds decompose at high temperature, they release halogen-containing species that quickly combine with energetic free radical combustion species to neutralize them and interrupt some of the major exothermal reaction channels of the combustion.

### Exemplary Methods of Making Treated Fiberglass and Composites

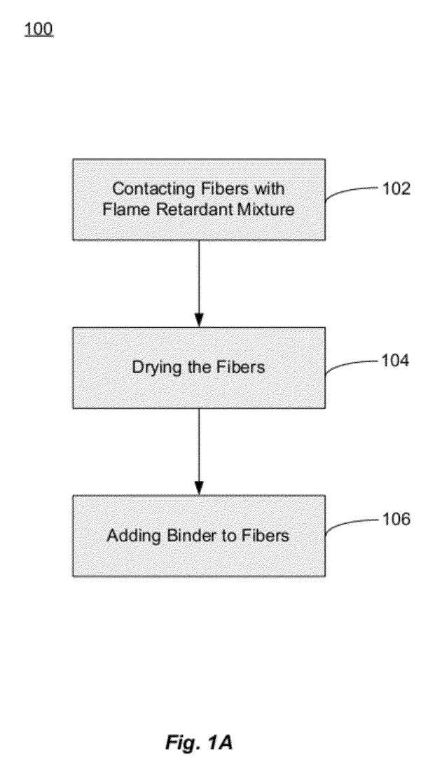

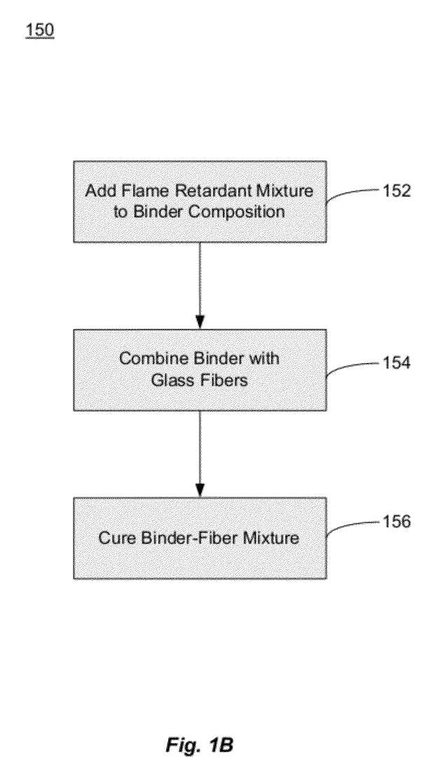

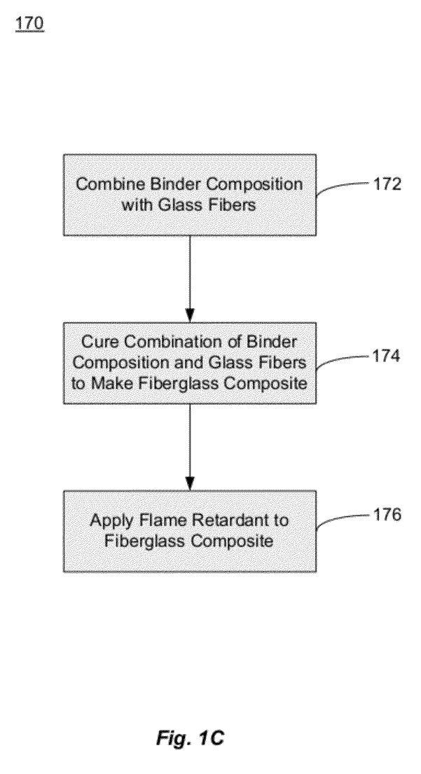

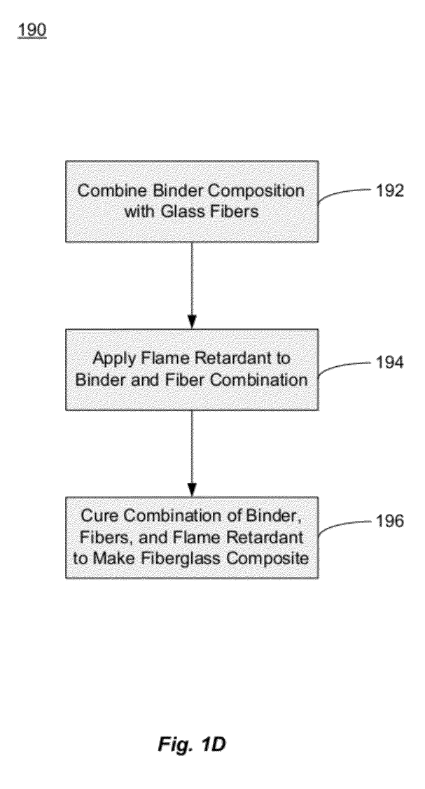

FIG. 1A shows a flowchart with selected steps in a method of making glass fibers with improved flame resistance according to embodiments of the invention. The method 100 includes the step of contacting glass fibers with a flame retardant mixture 102. The mixture may contact the fibers by any number of processes such as spraying, coating, and dipping, among other processes. For example, the glass fibers may be transported on a conveyor belt through a spray of the flame retardant mixture. In another example, the glass fibers and mixture may be mixed together in a slurry that is deposited on a moving screen to dewater the slurry and form a wet collection of the fibers. The wet fibers may then be transported either to a drying process (e.g., an oven) or contacted with additional mixtures (e.g., a binder composition) before being dried and/or cured.

As noted above, the flame retardant mixture may include vermiculite. The mixture may have the vermiculite dispersed in water or aqueous solution that is sprayed, coated, mixed, dipped, etc. on the glass fibers. The mixture may also include flame retardant compounds such as phosphorous compounds, metal hydroxides, carbon black, and/or a halogen-containing compounds, among other compounds. The mixture may further include organic and/or inorganic sizing compounds that aid in the uniform distribution and/or adherence of the vermiculite to the glass fibers. In some instances, these sizing compounds may include precursors that are similar and/or identical to the binder precursors.

The method 100 further includes drying the glass fibers to form the fibers with improved flame resistance 104. The drying process may include removing excess flame retardant mixture from the glass fibers in a dewatering step (e.g., draining the excess mixture though a porous screen or mesh that supports the glass fibers). Alternatively (or in addition) the drying process may include increasing the temperature of the glass fibers by, for example, placing the fiber in an oven or exposing the fibers to a heat source such as a heating element or blown hot air.

A binder composition may be optionally added to the treated glass fibers 106. The binder composition may be added before or after the glass fibers are dried. When the binder is added to the dried glass fibers, the combination of the binder composition and treated fibers may be dried and/or cured to form a fiberglass composite of the fibers and binder. The binder composition may optionally include the same or different flame retardant compounds than those used in the flame retardant mixture.

The flame retardant mixture may act as a sizing composition that adds flame retardants to the glass fibers' surfaces without binding the fibers together, or a binder composition that can also form a binder when cured. FIG. 1B shows selected steps in methods 150 of combing glass fibers with a flame retardant mixture that also acts as a binder composition. The method 150 includes the step of adding a flame retardant to a binder composition to form the flame retardant mixture 152. The flame retardant may include vermiculite that is added as a dry powder (e.g., platelets) or aqueous dispersion to the binder composition. Alternatively (or in addition) additional flame retardant components may be added to the binder composition independently from or with the vermiculite. As noted above, the flame retardant components may include a phosphorous compound, a metal hydroxide, carbon black, and/or a halogen-containing compound, among other compounds.

The binder composition to which the flame retardant is added may include a mixture of precursors that form the binder for the fibers of the composite when cured. Exemplary binder compositions may include starting materials for a polymeric binder such as an acrylic binder, a urea-formaldehyde binder, a phenol-formaldehyde binder, a silicate binder, a melamine-formaldehyde binder, and a latex binder, among other kinds of binders. The pre-polymerized binder composition may include starches, sugars, and/or proteins, among other materials, having varying degrees of polymerization.

Exemplary binder compositions may include one or more organic polyacids and one or more polyols that polymerize to form a formaldehyde-free binder such as a polyacrylic binder. The polyol may include three or more —OH moieties (e.g., triethanolamine, glycerol, etc.) that acts as a crosslinking agent as well as a co-monomer of the acrylic polymer backbone. The binder compositions may also include sugars, starches and proteins that act as extenders, covalently bound constituents of the polymer binder, or both.

Exemplary binder compositions that form silicon-containing binders may also be used. These binder compositions may include silicon silicate, potassium silicate, and/or quaternary ammonium silicate, among other silicates. The binder compositions may optionally further include organic compounds, oligomers, and/or polymers (e.g., latex, polyols, sorbitol, sugars, glycerin, etc.). The binder compositions may further include surfactants (e.g., anionic and/or non-ionic surfactants), curing aids such as metals salts (e.g., CaCl₂, MgSO₄, Al₂(SO₄)₃, ZnSO₄, Al PO₄, etc.), defoamers, water repellants, and fillers (e.g., clays, Atomite, etc.), among other compounds.

The flame retardant mixture that includes the binder composition may then be combined with the glass fibers 154 by spraying, mixing, coating, dipping, etc., as described above. They may also include curtain coating the binder on the fibers, and dip-and-squeeze coating the binder, among other application techniques. The combination of the binder mixture and glass fibers may then be dried and/or cured 156 to form a fiberglass composite. Exemplary techniques to dry and cure the applied binder may include oven drying and dry laying, among other techniques. In the final composite the glass fibers may, for example, represent about 50 wt. % to 98 wt. % of the composite, and the binder may represent about 2 wt. % to about 50 wt. % of the composite. In additional examples, the flame retardant in the binder and/or attached to the glass fibers may represent about 1 wt. % to about 25 wt. % of the final composite.

In additional methods the flame retardant mixture may be added to cured fiberglass composites as shown in FIG. 1C. The method 170 may include the step of combining a binder composition with glass fibers 172. The fibers may be untreated, or may optionally be treated with a sizing composition that includes the flame retardant. The combined mixture is then cured to form the fiberglass composite 174. The flame retardant mixture may then be applied to the fiberglass composite 176 as it is curing and/or after curing is finished. Exemplary applications of the flame retardant include spraying the retardant on exposed surfaces of the fiberglass composite.

In still other additional methods 190, the flame retardant mixture may added to the combination of the glass fibers and binder composition before it is cured or in a partially cured or prepreg state. The method 190 may include the step of combining the binder composition with glass fibers 192, followed by applying the flame retardant to the combination of binder composition and glass fibers 194. The combination of binder composition and glass fibers may be uncured, partially cured (i.e. B-stage cured), or a prepreg. The combination of the binder composition, fibers, and flame retardant mixture may then be cured or melted to form the fiberglass composite with improved flame resistance.

### Exemplary Methods of Making Fiberglass Insulation Products

The treated fiberglass and fiberglass composites described above may be used to make fiberglass insulation products with improved flame resistance. For example, the treated glass fibers may be formed into a fiberglass batt with improved flame resistance, as well as a flame resistant fiberglass mat. The mat and batt may function as insulation products themselves, or the mat may act as a facer that is attached to a fiberglass batt to make another insulation product. The same or different flame retardants may be incorporated into the mat, the batt, or both.

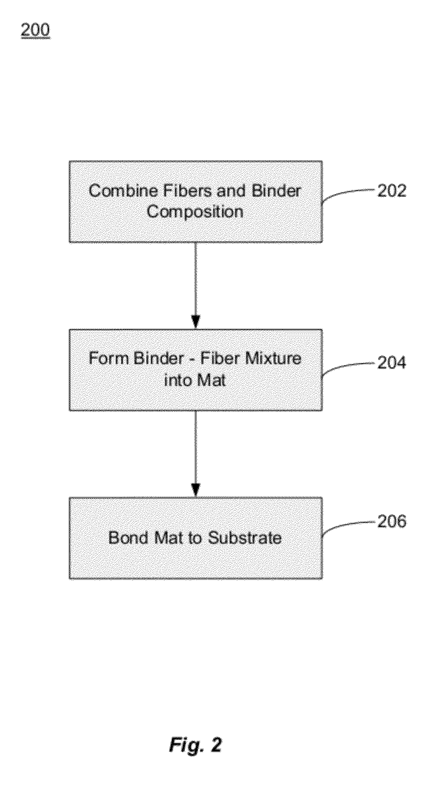

FIG. 2 illustrates selected steps in a method 200 of making a fiberglass-containing products according to embodiments of the invention. The method 200 may include making a fiberglass facer mat with increased flame resistance by combining glass fibers with a binder composition 202 and forming the combination into the fiberglass facer mat 204. Flame retardant that imparts the increased flame resistance to the mat may be incorporated into the binder, attached to the glass fibers, or both.

The fiberglass facer mat may then be bonded to a substrate material 206. The substrate may be a fiberglass batt formed from woven and/or non-woven glass fibers that may also have been treated with a flame retardant either on the fibers and/or in a binder that holds together the fibers. Alternatively (or in addition) the substrate may be insulation foam board that optionally includes flame retardant and glass fibers. The thickness of the insulation formed by the mat and batt may range, for example, from about 1 cm to about 5 cm or more.

The fiberglass facer mat and the substrate may be bonded while being formed or formed separately and then bonded. For example, the method 200 may involve first forming the fiberglass mat and then forming the fiberglass insulation batt on the mat by applying the mat to a collection chain on which the insulation batt is formed. Alternatively, both the mat and batt may be separately formed before being joined together.

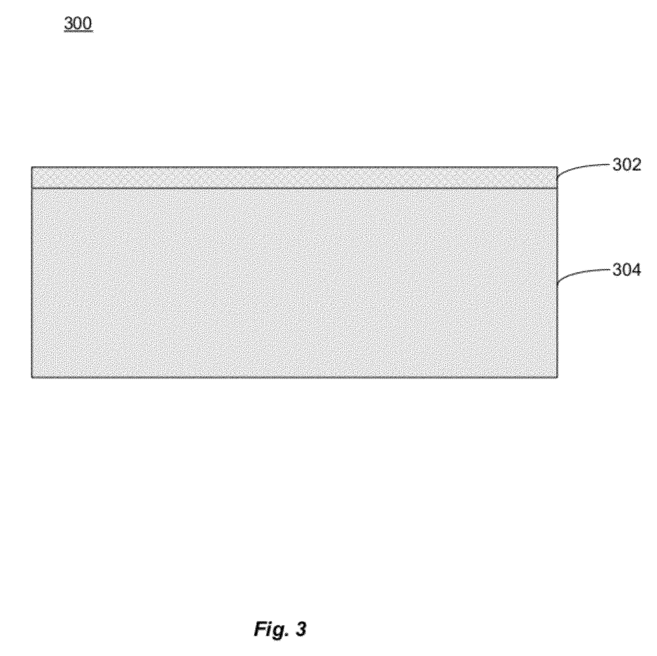

Referring now to FIG. 3, a simplified illustration of a fiberglass product is shown. The fiberglass product 300 includes a fiberglass mat facer 302 that includes glass fibers held together by a binder. A flame retardant may be present in the binder, on the glass fibers, or both. The mat facer 302 is bonded to a substrate such as a fiberglass batt 304. The mat may be bonded to the batt 304 by cured binder in the mat 302 and/or batt 304. Alternatively, the mat 302 may be bonded to a separately formed batt 304 using an adhesive.

The exemplary fiberglass composites, such as fiberglass insulation batt, fiberglass duct insulation, fiberglass mats, etc., treated with the present flame retardant compositions have an increased probability of passing a flame penetration test of the UL 181 Standard. This Standard was developed by Underwriter's Laboratories, Inc. for air ducts and connectors. The standard used in the present application is the UL 181 Standard for Factory-Made Air Ducts and Air Connectors, Flame Penetration Test (Section 10). In this test, the treated fiberglass composite is flattened and mounted in a frame that is placed over a flame at about 774° C., with the outside face of the duct in contact with the flame. The framed sample is loaded with a 3.6 kg weight over an area of 2.5 cm×10.2 cm. The fiberglass composite samples will fail if either the weight falls through the sample or the flame penetrates the sample. The sample is exposed to the flame for a period of 30 minutes.

The flame resistant fiberglass insulation may have applications as duct liner (e.g., Linacoustic RC™), and equipment liner (e.g., Micromat®), among other applications. Fiberglass duct liner are often designed for lining sheet metal ducts in air conditioning, heating and ventilating systems, and may help to control both temperature and sound. Fiberglass equipment liners are often blanket-type fiberglass insulation, used for thermal and acoustical control in HVAC equipment, as well as other equipment where reduced air friction, increased damage resistance, reduced operational noise, increased thermal performance, increased resistance to air erosion, increased ease of fabrication, installation, and handling, and attractive appearance, among other improved characteristics, are desired. Additional application of fiberglass equipment liners include their use with air conditioners, furnaces, VAV boxes, roof curbs, among other types of equipment.

### EXPERIMENTAL

Comparative tests were conducted to demonstrate the improved flame resistance of fiberglass products coated with fire retardants as described above. These tests include subjecting fiberglass batts and textiles treated with a flame retardant mixture to flame tests for an extended period of time. Comparative tests were performed on similar fiberglass materials that were not treated with the flame retardant mixture.

A treated fiberglass batt was made by combining JM flex glass having a weight of 2-10 g/ft² and R value of 4.2 with an aqueous dispersion of vermiculite (Microlite 903 from W.R. Grace & Co.). Following the application of the dispersion, the fiberglass batt is heated in an oven at 120° C. until the batt is dry.

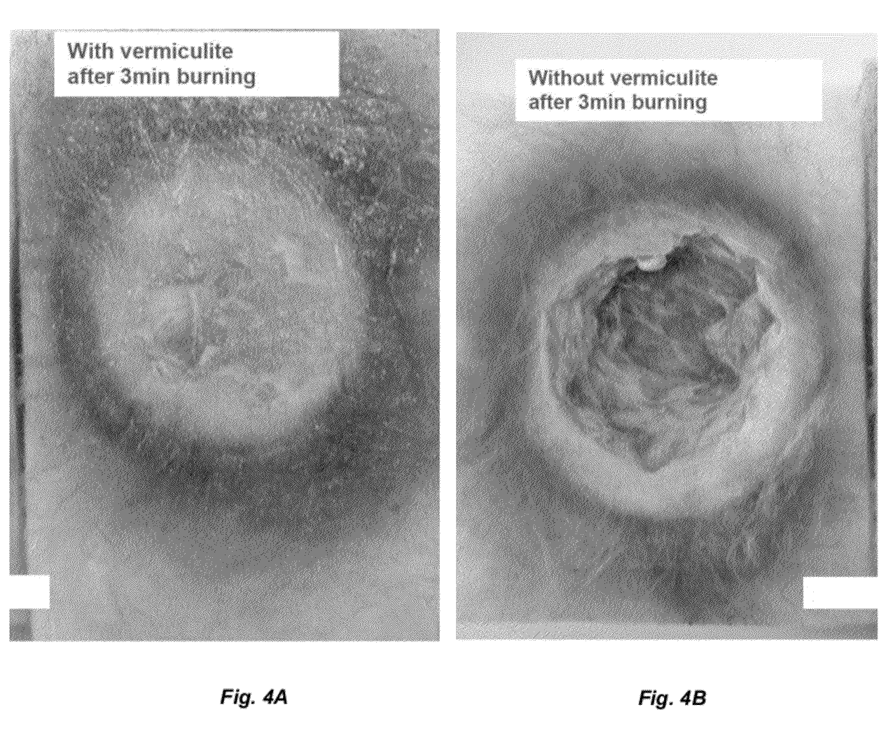

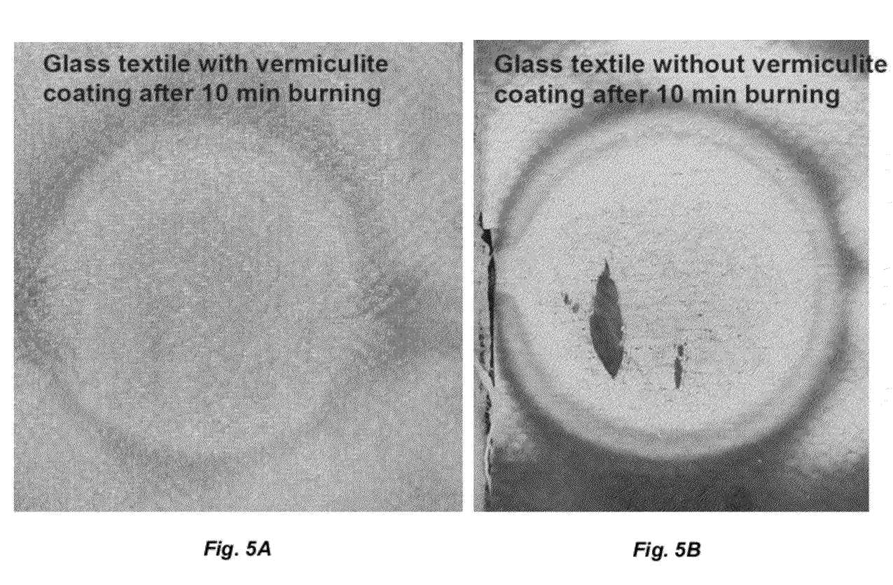

FIG. 4A shows a picture of the treated fiberglass batt after exposure to a Bunsen burner for three minutes. FIG. 4B shows a comparative picture of an untreated batt that is also exposed to the Bunsen burner for the same three minute period. The pictures clearly show the glass fibers exposed to the Bunsen burner flame substantially maintained their structural integrity, while the fibers of the untreated batt softened and melted to form a large cavity.

Similar tests were conducted on a same of woven glass textile exposed to a Bunsen burner flame for ten minutes. The treated material was made by brushing an aqueous vermiculite dispersion (Microlite 903) on a glass fiber textile and then drying the coated textile in an oven at 120° C. for 3 minutes. FIG. 5A shows a picture of the treated glass textile after the ten minute exposure to the Bunsen burner flame, while FIG. 5B shows the comparative picture of an untreated glass textile that was also exposed for 10 minute to the Bunsen burner flame. The pictures show again that the treated glass textile maintained its structural integrity while the glass fibers in the untreated textile softened and melted to form several holes through which the burner flames penetrated.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the glass mat” includes reference to one or more glass mats and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. Fiberglass-containing thermal insulation with increased resistance to flame penetration, the insulation comprising a plurality of glass fibers at least partially coated with a vermiculite containing flame retardant.

2. The insulation of claim 1, wherein the flame retardant further comprises a phosphorous compound, expandable graphite, a metal hydroxide, carbon black, or a halogen-containing compound.

3. The insulation of claim 1, wherein the plurality of glass fibers are incorporated into a fiberglass batt.

4. The insulation of claim 3, wherein the insulation further comprises a fiberglass mat in contact with the fiberglass batt, wherein the fiberglass mat also contains the flame retardant.

5. A fiberglass composite with improved flame resistance, the fiberglass composite comprising:
about 50 wt. % to about 98 wt. % glass fibers;
about 2 wt. % to about 50 wt. % of a binder; and
a flame retardant comprising vermiculite.

6. The fiberglass mat of claim 5, wherein the vermiculite is incorporated into the binder.

7. The fiberglass composite of claim 5, wherein the vermiculite is applied on the glass fibers.

8. The fiberglass composite of claim 5, wherein the flame retardant further comprises a phosphorous compound.

9. The fiberglass composite of claim 8, wherein the phosphorous compound is selected from the group consisting of a polyphosphate, an organic phosphorous compound,

10. The fiberglass composite of claim 5, wherein the flame retardant further comprises expandable graphite, metal hydroxide or carbon black.

11. The fiberglass composite of claim 5, wherein the flame retardant further comprises a halogen-containing compound.

12. The fiberglass composite of claim 5, wherein the binder comprises a filler material.

13. The fiberglass composite of claim 12, wherein the filler material is selected from the group consisting of kaolinite, mica, talc, fly ash, gypsum, montmorillonite, bentonite, smectite, calcium carbonate, clay, THA, and titanium dioxide.

14. The fiberglass composite of claim 5, wherein the flame retardant comprises about 1 wt. % to about 25 wt. % of the binder composition.

15. The fiberglass composite of claim 5, wherein the binder is made from one or more binder compositions selected from the group consisting of an acrylic binder, a formaldehyde-free binder, a urea-formaldehyde binder, a silicate binder, a protein-containing binder, a sugar-containing binder, a crosslinked starch containing binder, and a melamine formaldehyde binder.

16. The fiberglass composite of claim 5, wherein the glass fibers have a basis weight of about 135 g/m² to about 700 g/m².

17. The fiberglass composite of claim 5, wherein the fiberglass composite comprises flame resistant fiberglass duct insulation.

18. The fiberglass composite of claim 5, wherein the fiberglass composite is a flame resistant fiberglass insulation batt.

19. The fiberglass composite of claim 5, wherein the fiberglass composite is a flame resistant fiberglass mat.

20. The fiberglass composite of claim 19, wherein the fiberglass mat is a facer bonded to a substrate.

21. The fiberglass composite of claim 20, wherein the substrate comprises a fiberglass insulation batt.

22. A method of making glass fibers with improved flame resistance, the method comprising:
contacting glass fibers with a flame retardant mixture comprising vermiculite; and
drying the glass fibers to form the fibers with improved flame resistance.

23. The method of claim 22, wherein the flame retardant mixture further comprises one or more additional flame retardant compounds selected from the group consisting of a phosphorous compound, expandable graphite, a metal hydroxide, carbon black, and a halogen-containing compound.

24. The method of claim 22, wherein the flame retardant mixture further comprises an aqueous dispersion of the vermiculite in water.

25. The method of claim 22, wherein the flame retardant mixture further comprises an aqueous solution having one or more compounds selected from the group glycerin, sorbitol, sugar, starch, protein, and latex.

26. The method of claim 22, wherein the flame retardant mixture further comprises one or more binder precursors selected from the group consisting of a carboxylic acid, an anhydride, an alcohol, a vinyl compound, a polyol, a polymerization catalyst, an accelerator, a corrosion inhibitor, and an extender.

27. The method of claim 22, wherein the flame retardant mixture further comprises kaolinite, mica, talc, fly ash, gypsum, montmorillonite, bentonite, smectite, calcium carbonate, clay, THA, or titanium dioxide.

28. The method of claim 22, wherein the flame retardant mixture contacts the glass fibers by spraying, coating, or dipping the flame retardant mixture on the glass fibers.

29. The method of claim 22, wherein the drying of the glass fibers comprises blowing heated air on the glass fibers.

30. The method of claim 22, wherein the drying of the glass fibers comprises heating the glass fibers in an oven.

31. The method of claim 22, wherein the method further comprises forming the fibers with improved flame resistance into a fiberglass insulation batt.

32. The method of claim 22, wherein the method further comprises forming the fibers with improved flame resistance into a fiberglass mat.

33. The method of claim 22, wherein the method comprises forming the fibers with improved flame resistance into a fiberglass composite that has a higher passage rate for a flame penetration test of a UL 181 Standard compared to the same fiberglass composite that did not have fibers treated with the flame retardant mixture.

34. A method of making a fiberglass composite with increased flame resistance, the method comprising:
combining glass fibers with a binder composition;
curing the combination of glass fibers and the binder composition to form the fiberglass composite; and
applying a flame retardant mixture to the fiberglass composite, wherein the flame retardant mixture comprises vermiculite.

35. The method of claim 34, wherein the fiberglass composite comprises fiberglass insulation batt or fiberglass duct insulation.

36. The method of claim 34, wherein the fiberglass composite with increased flame resistance has a higher passage rate for a flame penetration test of a UL 181 Standard compared to the same fiberglass composite that was not treated with the flame retardant mixture.

37. A method of making a fiberglass composite with increased flame resistance, the method comprising:
combining glass fibers with a binder composition;
applying a flame retardant mixture to the combination of the glass fibers and the binder composition, wherein the flame retardant mixture comprises vermiculite;
curing the combination of the glass fibers, the binder composition, and the flame retardant mixture to form the fiberglass composite.

38. The method of claim 37, wherein the fiberglass composite with increased flame resistance has a higher passage rate for a flame penetration test of a UL 181 Standard compared to the same fiberglass composite that was not treated with the flame retardant mixture.
